(19) United States
(12) Patent Application Publication
(10) Pub. No.: US 2011/0119389 A1
(43) Pub. Date: May 19, 2011

(54) TRANSFERRING MULTIPLE COMMUNICATION MODALITIES DURING A CONVERSATION

(75) Inventors: Stéphane Cavin, Zurich (CH); Stephane L. Taine, Redmond, WA (US)

(73) Assignee: MICROSOFT CORPORATION, Redmond, WA (US)

(21) Appl. No.: 12/622,165

(22) Filed: Nov. 19, 2009

(51) Int. Cl. G06F 15/16; H04L 12/66

(52) U.S. Cl. 709/228; 370/352

(57) ABSTRACT

A conversation may be established using any supported type of communication modalities, including voice, video, desktop sharing, IM, application sharing , and the like. During the conversation, a user may transfer all or part of the modalities of the conversation at the same time to one or more destinations. The transfer may specify mandatory and non-mandatory modalities and may occur supervised or in a blind manner. In addition to transferring the modality, a conversation payload (e.g. IM history) may also be transferred to a destination.

### BACKGROUND

Different communication applications are designed to make communication easier and more accessible by providing users with a variety of information and functionality. For example, a user may have the ability to contact users through different communications methods, such as voice calls, text messages, instant messaging (IM), video and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A conversation includes different types of supported communication modality, such as voice, video, IM, application sharing, desktop sharing, and the like. During the conversation, a user may transfer all or part of the modalities of the established conversation to one or more destinations. The transfer may specify mandatory and non-mandatory modalities and may occur supervised or in a blind manner. In addition to transferring the modalities of the conversation, a conversation payload (e.g. IM history) may also be transferred to a destination.

### BRIEF DESCRIPTION OF THE DRAWINGS

FIG. 1 illustrates an exemplary computing environment;

FIG. 2 shows a communications system for transferring modalities of a conversation;

FIG. 3 shows an illustrative overview process for transferring modalities of a conversation;

FIG. 4 shows an illustrative process for a transfer of modalities of a conversation;

FIG. 5 shows an illustrative process for a supervised transfer of modalities of a conversation;

FIG. 6 shows an illustrative process where a non-mandatory modality of a conversation fails transferring; and

FIG. 7 shows an illustrative process where a mandatory transfer of a modality of a conversation fails.

### DETAILED DESCRIPTION

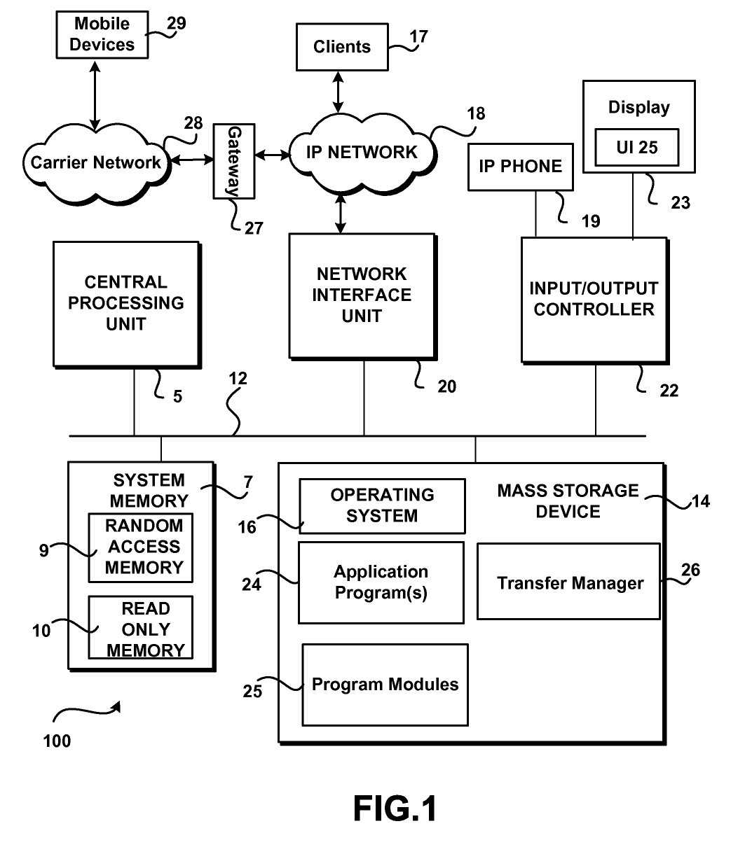

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, other program modules 25, and transfer manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone 19, a display screen 23, a printer, or other type of output device.

Carrier network 28 is a network responsible for communicating with mobile devices 29. The carrier network 28 may include both wireless and wired components. For example, carrier network 28 may include a cellular tower that is linked to a wired telephone network. Typically, the cellular tower carries communication to and from mobile devices, such as cell phones, notebooks, pocket PCs, long-distance communication links, and the like.

Gateway 27 routes messages between carrier network 28 and IP Network 18. For example, a call or some other message may be routed to a mobile device on carrier network 28 and/or route a call or some other message to a user's device on IP network 18. Gateway 27 provides a means for transporting the communication from the IP network to the carrier network. Conversely, a user with a device connected to a carrier network may be directing a call to a client on IP network 18.

As mentioned briefly above, a number of program modules and data files may be stored in the mass storage device 14 and RAM 9 of the computer 100, including an operating system 16 suitable for controlling the operation of a computer, such as WINDOWS COMMUNICATION SERVER®, WINDOWS SERVER® or the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs 24 and program modules 25.

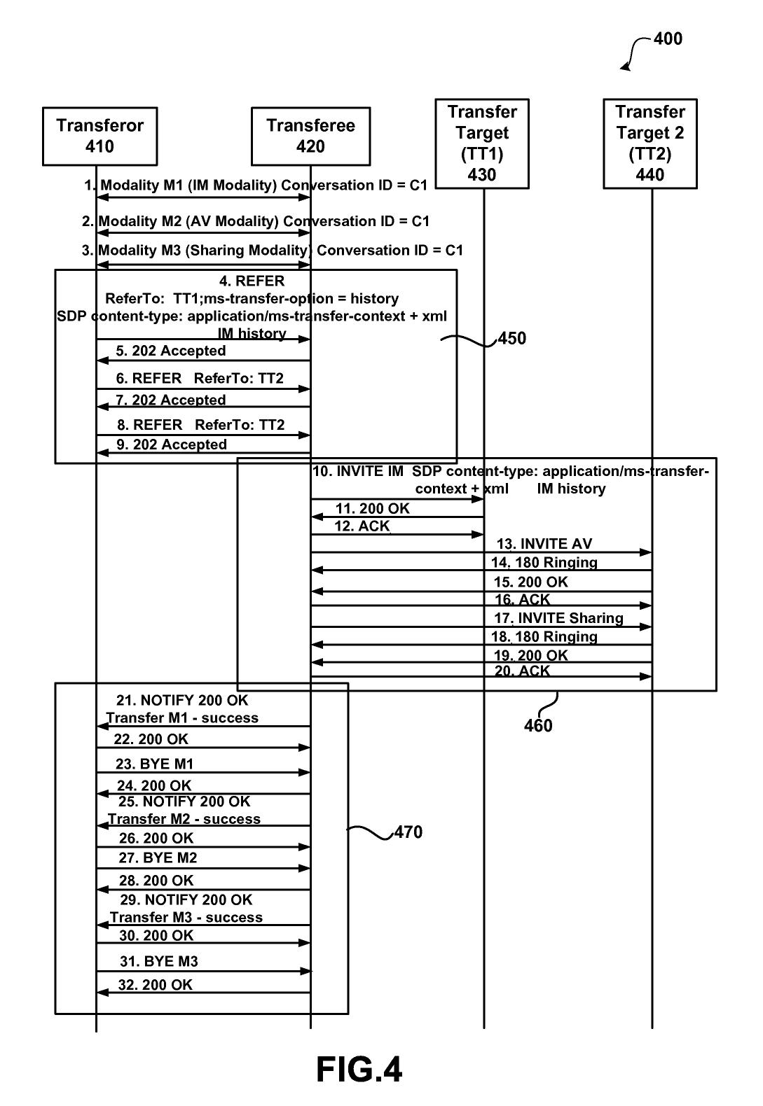

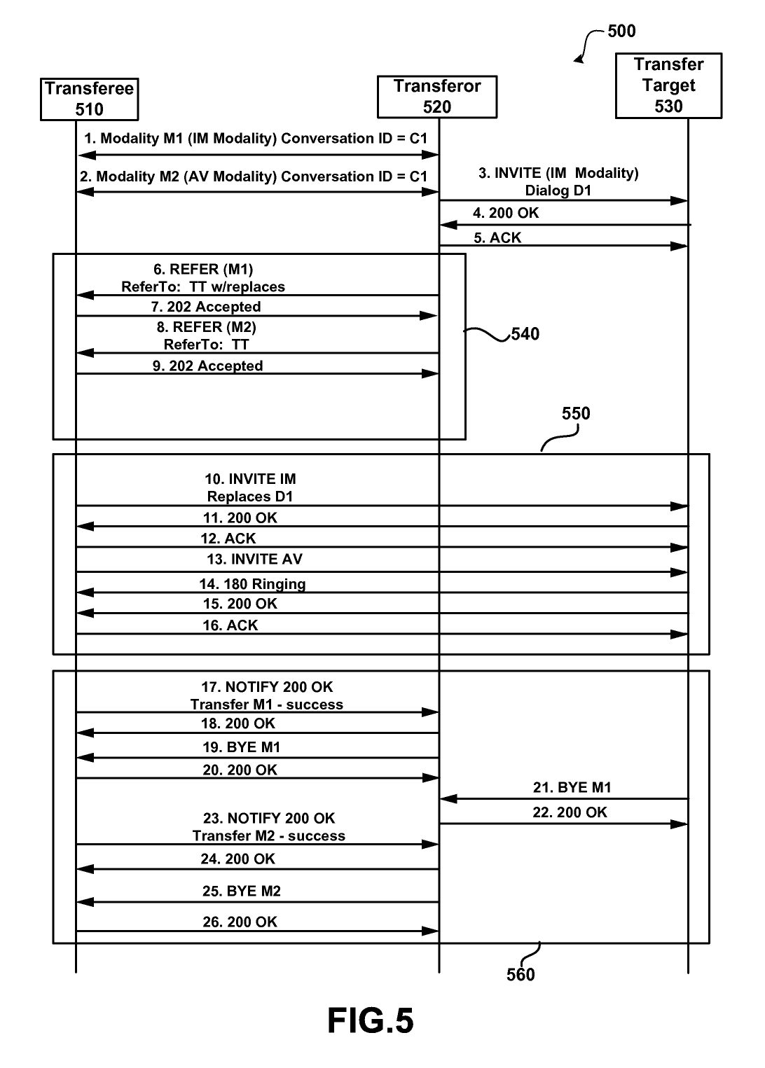

Transfer manager 26 is configured to transfer modalities of an established conversation to one or more destinations (transfer targets). According to one embodiment, transfer manager 26 is deployed on a client device within the communications network and initiates messages relating to transferring modalities of a conversation. The communication modalities within the conversation may include, but are not limited to: voice, video, application sharing, desktop sharing, Instant Messaging (IM), and the like. Transfer manager 26 may be configured to transfer modalities of a conversation in a supervised or blind manner. For example, transfer manager 26 may be used to initiate a dialog with a transfer target to determine whether or not the transfer target is able to accept the transfer of the modalities of the conversation. All or a part of the modalities of the modalities may be transferred in a supervised manner. For instance, a portion of the modalities may be transferred in a supervised manner to one transfer target and another portion of the modalities may be transferred in a blind manner to another transfer target (See FIGS. 4 and 5).

According to one embodiment, transfer manager 26 communicates with an application program 24 such as MICROSOFT's OFFICE COMMUNICATOR®. While transfer manager 26 is illustrated as an independent program, the functionality may be integrated into other software and/or hardware, such as MICROSOFT's OFFICE COMMUNICATOR®. The operation of transfer manager 26 is described in more detail below.

User Interface 25 may be utilized to select the communication modalities to transfer as well as specify the transfer targets for each modality of a conversation.

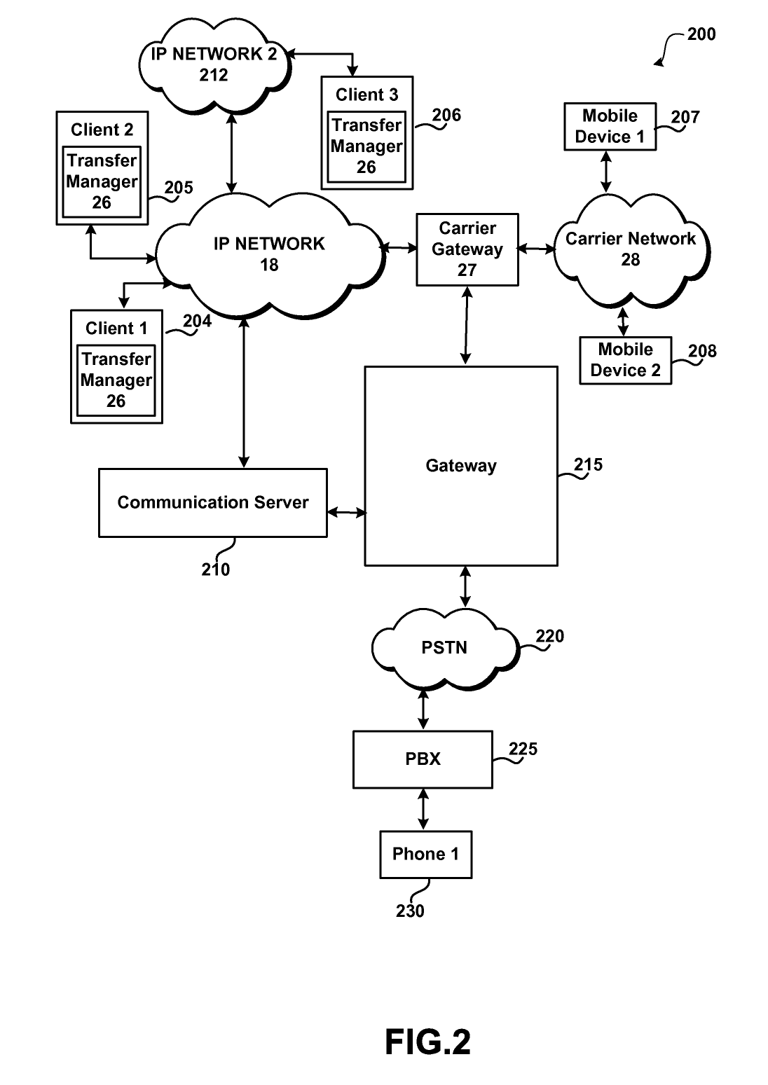

FIG. 2 shows a communications system for transferring modalities of a conversation at the same time. As illustrated, system 200 includes client 1 (204) and client 2 (205) that are coupled to IP Network 18, client 3 (206) that is coupled to IP Network 2 (212), mobile device 1 (207) and mobile device 2 (208) that are coupled to carrier network 28, communication server 210 including communications manager 26, carrier gateway 27, gateway 215 coupled to PBX 225 through PSTN 220 and phone 1 (230). Each of the clients includes a transfer manager 26 that is used in transferring modalities of the conversation. As briefly discussed above, transfer manager 26 is configured to generate messages for transferring different modalities of a conversation from one endpoint to another endpoint.

The communications server 210 is configured to route incoming calls to the appropriate destinations. Routing communication within system 200 may be done different ways. For example, a telephone number may be mapped to a Session Initiation Protocol (SIP) Uniform Resource Indicator (URI) using a Reverse Number Lookup (RNL) process. By performing reverse number lookup, the server 210 can route calls to endpoints associated with a particular user's SIP Uniform Resource Identifier (URI). The server may also utilize call authorization rules configured by an administrator to route each call to the appropriate media gateway (i.e. carrier gateway 27, gateway 215). According to one embodiment, communications server 210 utilizes SIP. For more information on this industry standard protocol see IETF RFC 3261 which may be found at http://www.ietf.org/rfc/rfc3261.txt. Generally, SIP defines a standard for session setup, termination, and media negotiation between two parties that is widely used for Voice-over-IP (VoIP) call signaling. The Session Description Protocol (SDP), or some other protocol, may also be utilized by the system to define how multimedia sessions can be organized as to allow the endpoints of the conversation to participate.

The communication server 210 routes calls to endpoints on the IP network (IP-IP calls); routes calls to the public switched telephone network (PSTN)/PBX (IP-PSTN calls) and may also route calls to destinations using other networks, such as a carrier network. The communication server may be coupled to the networks through one or more gateways. A gateway 215 translates signaling and media between the network and the IP voice infrastructure.

Communications server 210 may be configured to provide communication services for one or more locations. For example, communications server 210 may be utilized for a business having branch offices that are connected using IP Network 18 and/or other IP networks (e.g. IP Network 2 (212)). For example, Client 3 may be located at a branch office while communication server 210 is located at the main office.

Transfer manager 26 is configured to assist in transferring a conversation including different modalities to one or more transfer targets. For example, Client 1 and Client 3 may be involved in a conversation involving an IM modality and an audio-visual (AV) modality. At some point during the VoIP conversation, Client 1 may decide to transfer one or both of the modalities of the conversation to another endpoint. For instance, Client 1 may utilize a user interface to select the IM modality and the AV modality of the conversation to transfer to Client 2. Each modality of the conversation may be transferred to the same end point or different endpoints. In the current example, once the modalities of the conversation are transferred from Client 1 to Client 2, the conversation including the AV modality and the IM modality is between Client 2 and Client 3. In addition to transferring the modalities of the conversation, a conversation payload may also be transferred. Generally, the conversation payload is data that relates to the information generated and/or used during the established conversation. For example, a conversation payload may be information relating to the modality such as: an IM history, application data, and the like. According to one embodiment, when a conversation payload is to be transferred, the SIP transaction (REFER) includes a transfer-option indicating the conversation payload to transfer as well as the data of the conversation payload (See FIG. 4). According to one embodiment, the conversation payload is included within a transfer context.

After referring the different modalities of the conversation to the transferee (in this case, Client 3, Client 3 issues a new SIP transaction (INVITE) for each communication modality to the desired transfer target(s) (in this case, Client 2).

Once the transfer target(s) (i.e. Client 2) accepts the invitations, the transferee (Client 3) sends a SIP transaction (NOTIFY) to the transferor (Client 1) indicating a success or failure of the transfers. According to one embodiment, the transferor does not terminate a modality of the conversation of the established conversation until the notification of a successful transfer is received from the transferee. According to another embodiment, the modalities transferred may be terminated at any point after they are referred to the transferee.

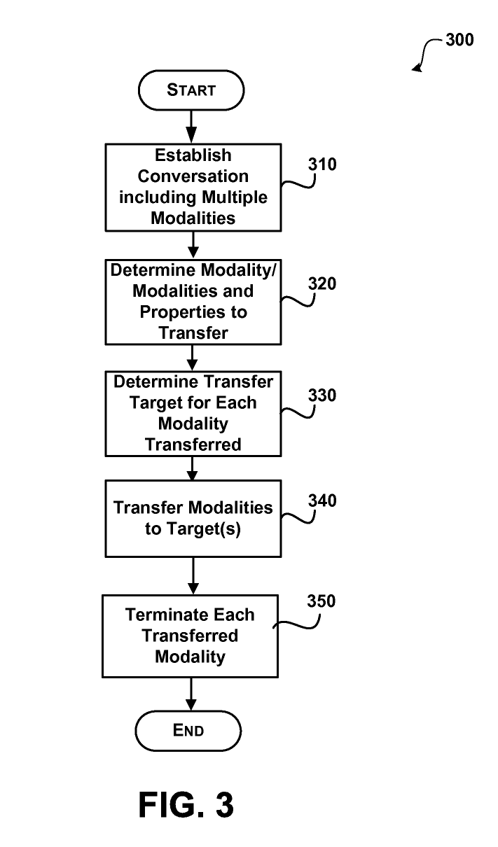

Referring now to FIGS. 3-5, illustrative processes for transferring modalities of a conversation will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 3, an overview process of transferring multiple modalities of a conversation is described.

After a start operation, the process flows to operation 310, where a conversation including different modalities is established between at least two users. The conversation may include any type of supported communication mode. For example, the conversation may be an IM modality, a video modality, a voice modality, an application sharing modality, an audio visual modality, and the like. A conversation is established when a user accepts the communication request from another user.

Moving to operation 320, a determination is made as to what modalities of the conversation are to be transferred as well as the properties of the modality that will be transferred. According to one embodiment, a user utilizes a user interface to select the modalities and properties to transfer. For example, the user interface may show the active conversations with their modalities and allow the user to select the modalities of the conversation to transfer. According to one embodiment, the user selects all of the modalities of the conversation to transfer to one or more transfer targets. The user may also determine the properties of the modality to transfer. For instance, a determination may be made as to whether to transfer the conversation payload for the modality when the modality is transferred. For example, the user may decide to transfer the IM history for a conversation when an IM modality is transferred, transfer video when a video modality is transferred, transfer application data when an application sharing modality is transferred, and the like.

Transitioning to operation 330, the transfer target for each modality selected is determined According to one embodiment, the user interface may used to associate a transfer target with each modality to be transferred. Any number of the modalities of the conversation may be associated with a single transfer target. For example, when a conversation has three different modalities, all three may be transferred to a single transfer target, or two of the three modalities may be transferred to one target while the third modality is transferred to a different transfer target or each modality may be transferred to a different target.

Flowing to operation 340, each modality is transferred to the determined transfer target(s). According to one embodiment, the transfers are completed using the SIP protocol.

Moving to operation 350, the transferred modalities are terminated. According to one embodiment, a modality is not terminated from the original conversation until a notification is received stating that the modality has been successfully transferred to the transfer target.

The process then flows to an end block and returns to processing other actions.

FIG. 4 shows an illustrative process for transferring modalities of a conversation. As illustrated, process 400 includes transferor 410, transferee 420, transfer target (TT1) 430, and transfer target 2 (TT2) 440. While two transfer targets are illustrated, there may be more or fewer transfer targets. For example, there may be only one transfer target or three transfer targets.

Steps one to three illustrate establishing three different modalities between transferor 410 and transferee 420. As illustrated, an IM modality, an audio-visual modality, and an application sharing modality are established and associated with a single conversation (C1). More or fewer communication modalities may be established.

Box 450 illustrates steps 4-9 in which transferor 410 transfers the modalities of the conversation C1 to transferee 420. In step 4, transferor 410 transfers the IM modality and selects transfer target TT1 (430). In this transfer, the transferor 410 has decided to include the IM history along with the transfer of the IM modality. As shown, the REFER message includes the transfer-option of “history” indicating to transfer the payload of the conversation (in this case the IM history). Steps 6-9 illustrate transferring the AV modality and the application sharing modalities to transfer target TT2 (440). Each modality transferred may have an associated conversation payload that is transferred along with the modality. For example, the AV modality may have video content, or other content, that is transferred as the conversation payload. Similarly, the application sharing content may have items such as what application is being shared, links to resources being shared, one or more documents being shared, and the like, that are transferred as the conversation payload. According to one embodiment, all or a portion of the conversation payload may be transferred. For example, a selection may be made (e.g. using a user interface) that selects what content to transfer within the conversation payload.

Box 460 illustrates steps 10-20 in which the transferee 420 is inviting the transfer targets TT1 and TT2 to accept the transfer of the modalities of conversation C1. Steps 10-12 show transferee 420 inviting TT1 (430) to accept the IM modality along with the IM history. Steps 13-20 illustrates transferee 420 inviting TT2 (440) to accept the AV modality and the Application sharing modality.

Box 470 shows the transferee 420 providing the transferor 410 with the results of each of the transferred modalities. When, transferor 410 is notified of a successful transfer, transferor 410 terminates that modality from the established conversation.

Referring now to FIG. 5, a process flow for transferring modalities of a conversation using a supervised transfer is described. As illustrated, process 500 includes transferee 510, transferor 520 and transfer target (TT) 530. While one transfer target is illustrated, there may be more transfer targets. For example, there may be two or more transfer targets. Further, while a supervised transfer for each of the modalities is illustrated, any number of the modalities of the conversation may be transferred in a supervised manner.

Steps one to two illustrate establishing two different modalities within a conversation between transferee 510 and transferor 520. As illustrated, an IM modality and an audio-visual modality are established and associated with a single conversation (C1). More or fewer communication modalities may be established with a single conversation.

Steps three to five shows the transferor 520 establishing a dialog with transfer target 530 to determine whether or not to transfer the modalities that are established between transferee 510 and transferor 520 and is part of conversation C1.

Box 540 illustrates steps 6-9 in which transferor 520 sends a refer request to transferee 510 to replace the transferor 520 with transfer target 530 after the transfer target 530 has accepted the transfer request in response to the dialog between transfer target 530 and transferor 520. The transferor 520 sends the transfer requests to the transferee 510 notifying which dialogs are to be replaced. In this supervised transfer example, a conversation payload is not transferred (e.g. the IM history between transferee 510 and transferor 520 will not be transferred to transfer target 530). As shown, the REFER message includes the transfer-option of “history” indicating to transfer the payload of the conversation (in this case the IM history).

Box 550 illustrates steps 10-16 in which the transferee 510 is inviting TT 530 to accept the transfer of the modalities of conversation C1. Steps 10-12 show transferee 510 inviting TT (530) to accept the IM modality and replace the dialog D1 with the IM modality. Steps 13-16 illustrates transferee 510 inviting TT (530) to accept the AV modality.

Box 560 illustrates steps 17-26 in which the transferee 510 is notifying the transferor 520 that the transfers of the modalities are successful. In response to the successful notification for the transferred modality, the modality of the original conversation between the transferee 510 and the transferor 520 is terminated.

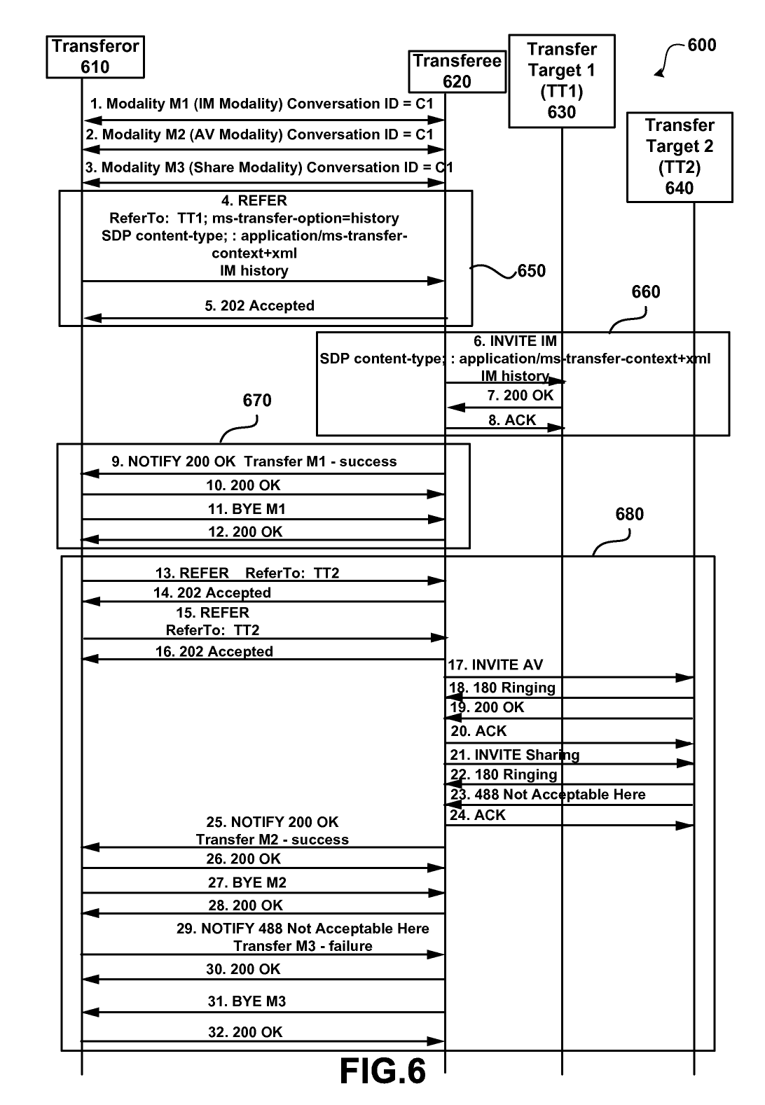

FIG. 6 shows an illustrative process where a non-mandatory modality of a conversation fails transferring. As illustrated, process 600 includes transferor 610, transferee 620, transfer target (TT1) 630, and transfer target 2 (TT2) 640. While two transfer targets are illustrated, there may be more or fewer transfer targets.

Steps one to three illustrate establishing three different modalities between transferor 610 and transferee 620. As illustrated, an IM modality, an audio-visual modality, and an application sharing modality are established and associated with a single conversation (C1). More or fewer communication modalities may be established.

Box 650 illustrates steps 4-5 in which transferor 610 transfers the modalities of the conversation C1 to transferee 420. In this example, the user has prioritized one modality (the IM modality) of the conversation over the other modalities and has specified that the IM modality must be successful before the other modalities of the conversation are to be transferred. The prioritization of the modalities may be determined from a user interface or in some other manner. According to one embodiment, a default prioritization may be configured for each of the available modalities in the conversation. For example, it may be determined that in one operating scenario that some of the modalities must be transferred before the transferor attempts to transfer the other modalities of the conversation. In this example, the transferor 610 has made the selection that the IM modality is to be transferred first and that if the transfer of the IM modality fails then the other modalities are not transferred. In step 4, transferor 610 transfers the IM modality to transferee 620 and selects transfer target TT1 (630) as the destination for the transfer. In this transfer, the transferor 610 has decided to include the IM history along with the transfer of the IM modality.

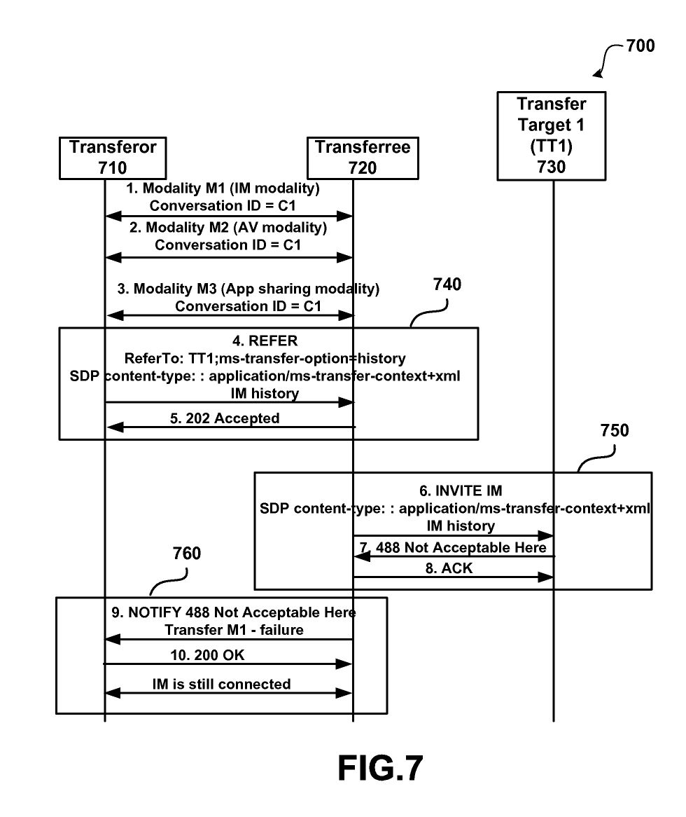

Box 660 shows steps 6-8 illustrating the transferee 620 inviting TT1 630 to accept the transfer of the IM modality and TT1 630 accepting the transfer. Box 670 illustrates steps 9-12 showing the transferee 620 notifying the transferor 610 of the successful transfer of the IM modality. Since the transfer of the IM modality is successful, the transferor terminates the IM modality of conversation C1. If the transfer of the IM modality was not successful in this example, then the other modalities would not attempted to be transferred (See FIG. 7 and related discussion).

Box 680 illustrates steps 13-32 showing the transferring of the AV modality and the application sharing modality to transfer target TT2 (640) after the successful transfer of the IM modality that was prioritized to be a mandatory transfer. Steps 13-16 show the transferor 610 referring the remaining modalities to transferee 620. Steps 17-20 show the transferee 620 inviting TT2 (640) to accept the AV modality and TT2 640 accepting the invitation. Steps 21-24 show the transferee 620 inviting TT2 (640) to accept the sharing modality and TT2 640 not accepting the invitation to transfer the sharing modality. Steps 25-28 illustrates transferee 620 notifying the transferor 610 of the success of the AV modality transfer and the transferor 610 terminating the AV modality. Steps 29-32 illustrates transferee 620 notifying the transferor 610 of the unsuccessful attempt to transfer the sharing modality and the transferor 610 terminating the sharing modality from the conversation.

FIG. 7 shows an illustrative process where a mandatory transfer of a modality of a conversation fails. As illustrated, process 700 includes transferor 710, transferee 720, transfer target (TT1) 730. While one transfer target is illustrated, there may be more transfer targets.

Steps one to three illustrate establishing three different modalities between transferor 710 and transferee 720. As illustrated, an IM modality, an audio-visual modality, and an application sharing modality are established and associated with a single conversation (C1). More or fewer communication modalities may be established.

Box 740 illustrates steps 4-5 in which transferor 710 transfers the modalities of the conversation C1 to transferee 420. In this example, the user has prioritized one modality (the IM modality) of the conversation over the other modalities and has specified that the IM modality transfer is mandatory. In this example, the IM modality is to be transferred first and that if the transfer of the IM modality fails then the other modalities are not transferred. In step 4, transferor 710 transfers the IM modality and selects transfer target TT1 (730). In this transfer, the transferor 710 has decided to include the IM history along with the transfer of the IM modality.

Box 750 shows steps 6-8 illustrating the transferee 720 inviting TT1 730 to accept the transfer of the IM modality. In this example, the transfer of the IM modality to TT1 730 was not successful.

Box 760 illustrates steps 9-10 showing the transferee 720 notifying the transferor 710 of the unsuccessful transfer of the IM modality. Since the transfer of the IM modality was unsuccessful, the transferor does not terminate the IM modality of conversation C1 and the conversation remains the same as the time before the transfer of the conversation was attempted.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for transferring modalities of a conversation over an Internet Protocol (IP) network, comprising:
establishing a conversation over the IP network including different modalities between a transferee and a transferor;
using a processor to determine when to transfer the different modalities used in the conversation;
determining at least one transfer target to transfer the different modalities of the conversation; and
transferring each of the different modalities to the determined transfer target.

2. The method of claim 1, wherein the different modalities of communication comprise at least two of the following modalities: a voice modality; an Instant Messaging modality; a video modality; an application sharing modality, and a desktop sharing session.

3. The method of claim 2, wherein transferring the different modalities to the transfer target comprises performing a supervised transfer of at least one of the different modalities transferred.

4. The method of claim 1, further comprising transferring a conversation payload for a modality that is transferred, wherein the conversation payload is data used during the established conversation.

5. The method of claim 4, wherein the conversation payload transferred is an IM history when an IM modality is transferred.

6. The method of claim 1, further comprising terminating each of the transferred modalities within the established conversation after the modality is transferred.

7. The method of claim 6, wherein terminating each of the transferred modalities within the established conversation after the modality is transferred comprises terminating only successfully transferred modalities.

8. The method of claim 1, further comprising specifying a modality of the conversation to be a mandatory modality and transferring the mandatory modality before attempting to transfer the other modalities of the conversation.

9. The method of claim 2, further comprising receiving selections of the transfer target and the different modalities of the conversation to transfer through a user interface.

10. A non-transitory computer-readable storage medium having computer-executable instructions for transferring modalities of a conversation over an Internet Protocol (IP) network, comprising:
establishing a conversation over the IP network including at least two different modalities between a transferee and a transferor;
determining when the to transfer the different modalities of the conversation to one or more transfer targets;
transferring the different modalities from the transferor to the determined transfer target;
receiving at the transferor a notification indicating a result of the transfers of the modalities; and
terminating the modalities upon receiving the notification indicating the result of the transfers is successful.

11. The computer-readable storage medium of claim 10, wherein the different modalities of communication comprise at least two of the following modalities: an Instant Messaging modality; a video modality; a desktop sharing modality, and an application sharing modality.

12. The computer-readable storage medium of claim 11, wherein transferring the different modalities from the transferor to the transfer target comprises supervising the transfer.

13. The computer-readable storage medium of claim 11, further comprising transferring a conversation payload for at least one of the modalities that is transferred; wherein the conversation payload includes data saved during the established conversation between the transferor and the transferee.

14. The computer-readable storage medium of claim 11, further comprising specifying a modality of the conversation to be a mandatory modality and when the transfer of the mandatory modality is unsuccessful returning the conversation to a state of the conversation before the transfer attempt.

15. The computer-readable storage medium of claim 11, further comprising receiving selections of the transfer target and the different modalities of the conversation through a user interface.

16. A system for transferring modalities of a conversation over an Internet Protocol (IP) network, comprising:
a network connection that is configured to connect to the IP network;
a processor and a computer-readable medium;
an operating environment stored on the computer-readable medium and executing on the processor; and
a transfer manager operating under the control of the operating environment and operative to:
determining when the to transfer different modalities of an established conversation on the IP network to one or more transfer targets;
transferring the different modalities to the transfer target;
receiving for each transferred notification a result indicating a success or a failure of the transfer for each of the modalities; and
terminating the modalities for each transferred modality within the established conversation.

17. The system of claim 16, wherein the different modalities of communication comprise at least two of the following modalities: an Instant Messaging modality; a video modality; and an application sharing modality.

18. The system of claim 16, wherein transferring the different modalities from the transferor to the transfer target comprises supervising at least one transfer of the different modalities.

19. The system of claim 16, further comprising transferring a conversation payload for at least one of the modalities that is transferred; wherein the conversation payload includes data saved during the established conversation between the transferor and the transferee.

20. The system of claim 16, further comprising a display that is configured to display a user interface that receives selections to determine the transfer target and the different modalities of the conversation to transfer.
